(19) United States
(12) Patent Application Publication
(10) Pub. No.: US 2005/0229013 A1
(43) Pub. Date: Oct. 13, 2005

(54) Apparatus and method for digital content concealment in a storage medium recorded using a recording device

(76) Inventors: Stanley Babowicz, PHOENIX, AZ (US); John D. Aquilino, Phoenix, AZ (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 10/478,701

(22) PCT Filed: May 21, 2002
(86) PCT No.: PCT/US02/15972

§ 371 Date: Aug. 20, 2004

Related U.S. Application Data
(62) Division of application No. 60/292,347, filed on May 21, 2001.

(51) Int. Cl. G06F 12/14

(52) U.S. Cl. 713/193; 369/53.21

(57) ABSTRACT

A system and process for the concealment of digital content recorded on a storage medium such as a compact disc (CD) and, more specifically, to an apparatus and method for recording a CD or other storage medium using a recording drive, such as a CD-R or CD-RW drive, that is connected to a computer and that conceals the stored digital content on the medium from being read by a compact disc read-only memory (CD-ROM) or other digital-based reader or computer device, for example as done when performing digital audio extraction (also known as ripping) of musical content from an audio CD. The apparatus and method permit improved control of the usage and copying of published content on physical media by an immediate purchaser while limiting copying and distribution of the content to unauthorized recipients.

### BACKGROUND OF THE INVENTION

This invention relates in general to the concealment of digital content recorded on a storage medium such as a compact disc (CD) and, more specifically, to an apparatus and method for recording a CD or other storage medium using a recording drive, such as a CD-R or CD-RW drive, that is connected to a computer and that conceals the stored digital content on the medium from being read by a compact disc read-only memory (CD-ROM) or other digital-based reader or computer device, for example as done when performing digital audio extraction (also known as ripping) of musical content from an audio CD. The apparatus and method of the present invention permit improved control of the usage and copying of published content on physical media by an immediate purchaser while limiting copying and distribution of the content to unauthorized recipients.

Individuals commonly use a recording drive connected to a personal computer to record audio CDs (this process is also known as burning CDs). So-called burning software, such as sold by Adaptec and other companies, is used to control the computer during the CD burning process. The recorded CDs may be made using standard CD-R and CD-RW recordable storage mediums.

Individuals typically use such recorded CDs to create compilations of music that may be obtained from multiple different sources. Such sources include audio CDs purchased by the individual, MP3 music files downloaded from the Internet, and digital music files using other standard formats. These sources may further include music files obtained under a digital rights management (DRM) system. For example, an individual may purchase several audio CDs and then record selected music tracks from each CD to a newly created compilation CD-R.

A problem with existing CD burning software is that the audio CDs created can be distributed to other individuals who can use the newly-created CD to create yet other audio CDs or additional digital copies of the music content on the CD. Further, existing CD burning software does not use a copy protection mechanism to control the use and/or subsequent copying of such content. In many cases, the individuals receiving a newly-created CD from an original purchaser of the source CD will not be authorized or otherwise have the right to make or distribute copies of the music content. However, audio CDs made using existing burning software will permit unauthorized individuals to use a newly-created CD to upload the music content to an Internet server or other computer for public distribution or to create additional audio CDs that may be improperly distributed.

The music and other entertainment industries have a business interest in promoting sales of CDs and other storage medium containing entertainment content. However, the music and entertainment industries desire to control the burning and handling of CDs by customers in a way that restricts unauthorized distribution to others who have not purchased or acquired a right from the publisher to receive entertainment content.

Thus, there is a need for an audio CD recording system that permits audio CD consumers to make compilation CDs for personal use, but that controls or prevents the unauthorized uploading to the Internet or making of subsequent CD copies using the compilation or other audio CD recorded by the consumer without requiring hardware modifications or modification of the actual data content itself There is a further need for compilation CDs made using this audio CD recording system to retain full playability in audio CD players in order to meet current consumer expectations regarding the use of purchased audio CDs and audio CDs burned from these purchased CDs.

### BRIEF DESCRIPTION OF THE DRAWINGS

FIG. 1 is a schematic diagram of a compact disc recording system according to the present invention;

FIG. 2 illustrates the contents of a multiple session compact disc recorded using the recording system of FIG. 1;

FIG. 3 is a flow diagram illustrating a recording method for a storage medium using digital content concealment according to the present invention;

FIG. 4 illustrates the standard subcode structure for audio CDs;

FIG. 5 illustrates the standard channel Q data format for the subcode structure of FIG. 4;

FIG. 6 illustrates the standard mode I Data-Q lead-in track format for the channel Q data format of FIG. 5;

FIG. 7 illustrates the standard mode I Data-Q audio and lead-out track format for the channel Q data format of FIG. 5;

FIG. 8 is a table illustrating an example of a table of contents (TOC) according to the present invention for a first session of a CD;

FIG. 9 is a table illustrating an example of a table of contents according to the present invention for a second session of a CD; and

FIG. 10 is a table illustrating an example of modified CRC values in the channel Q data of the program area of a CD according to the present invention.

FIG. 11 is a table illustrating an example of modified ATime values in the channel Q data of the program area of a CD according to the present invention.

### DETAILED DESCRIPTION OF THE PREFERRED EMBODIMENT

The present invention provides an apparatus and method for concealing digital content on a physical medium such as, for example, a CD that is recorded using a computer recording system and that permits improved control over the copying and distribution of the content stored on the CD. In a specific embodiment, the recording system according to the present invention permits an individual to use a personal computer to burn a first audio CD that incorporates copy protection and to prevent further copying of the music content from that CD. By preventing further copying, the burned CD cannot be used as an improper source of music to be uploaded to, for example, the Internet or for use in burning additional CDs. The present invention is discussed below in the non-limiting example of an audio CD, but may be generally used with other types of digital storage media including, for example, CD-ROMs and DVDs. Accordingly, the present invention extends to and is useful with these other media.

According to the present invention, digital content on a CD recorded using the recording system as described herein is concealed by making modifications to the control data that is located in the so-called “lead-in area” and stored along with the audio content on the CD. Modifications are also made to certain error checking and timing values that are located in the so-called “program area” and used to respectively verify a lack of errors in the associated control data and provide timing information. These modifications are discussed in more detail below.

In addition, according to the present invention, the recorded CD is also made into a multiple session CD having first and second sessions in which the first session actually contains audio data, but is coded to indicate that it contains digital data, and has intentional errors introduced to its control data as described below. The second session contains digital data in a standard format, which may include, for example, data identifying the creation date or source of the newly-burned CD or an HTML file that contains information and/or a URL associated with a music publisher or distributor or an artist. When a burned CD created according to the present invention is placed into a personal computer, the first session, and hence the audio content, is not readable by the computer. Instead, the computer may display information to the user corresponding to the data stored in the second session or launch a computer program stored in the second session. The foregoing and other aspects of the present invention are discussed in more detail below.

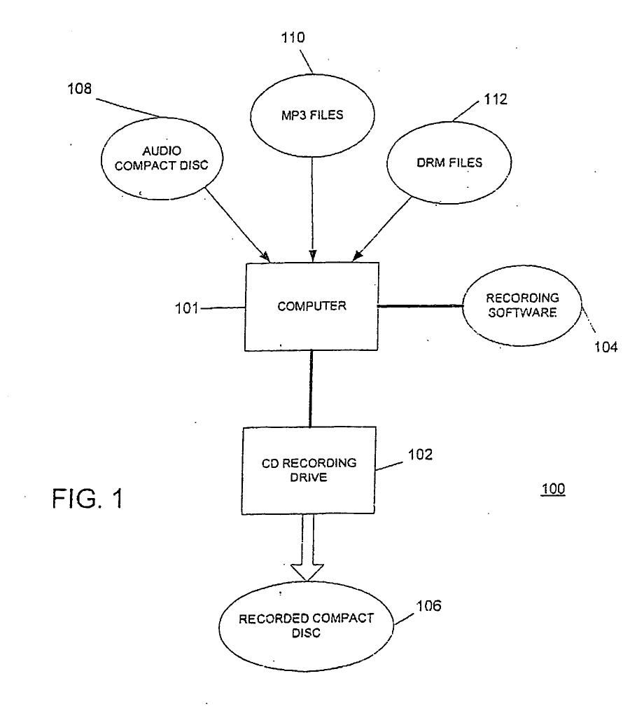

FIG. 1 is a compact disc recording system 100 according to the present invention and includes a computer 101 connected to or incorporating a CD recording drive 102. Computer 101 may be a personal computer such as, for example, a MICROSOFT WINDOWS and INTEL-based machine. Other computers may also be used as will be recognized by one of skill in the art. Recording drive 102 is, for example, a CD-R or CD-RW drive that is capable of recording or burning standard CDs. To use the digital content concealment approach as described below, recording drive 102 must be capable of supporting so-called raw mode burning due to the need to encode data into the subcode structure of CD 106.

Recording software 104 runs on computer 101 and controls computer 101 and drive 102 to create a recorded compact disc 106. Recording software 104 may be programmed in C++or other conventional computer languages to implement the functionality and digital concealment approach as described further below. Recording software 104 may also be written as a so-called “plug-in” to work in conjunction with a media player such as, for example, Microsoft Corporation's WINDOWS MEDIA PLAYER. Recording software 104 may, for example, provide options for selection by the user of the burning speed, selection of the files (stored on computer 101) to be burned to CD 106, and an interface that indicates the percentage complete or progress of the burning operation.

The source of content to be recorded on CD 106 may include, for example, music from standard audio CD 108, MP3 files 110 downloaded to computer 101 from the Internet, and Digital Rights Management (DRM) files 112. These and other sources of music can be used with the present invention. In general, music from each source is conventionally converted to a WAV format prior to burning CD 106. Optionally, the source of content could contain a flag that is readable by recording software 104 and that instructs recording software 104 regarding the specific manner or form of digital concealment that recording software 104 incorporates into CD 106.

Compact disc manufacturing and production technology is established according to a series of international publications, herein referred to as “standards”, all of which are incorporated herein by reference as if set forth fully herein. For example, some common standards applicable to CDs include: the International Standards Organization (ISO) standard 9660 entitled “Information Processing—Volume and File Structure of CD-ROM for Information Interchange, ISO Standard 13490-1”, the International Electrotechnique Commission (CEI-IEC) standard 908, also known as the “Red Book”, and ISO/IEC 10149, also known as the “Yellow Book”.

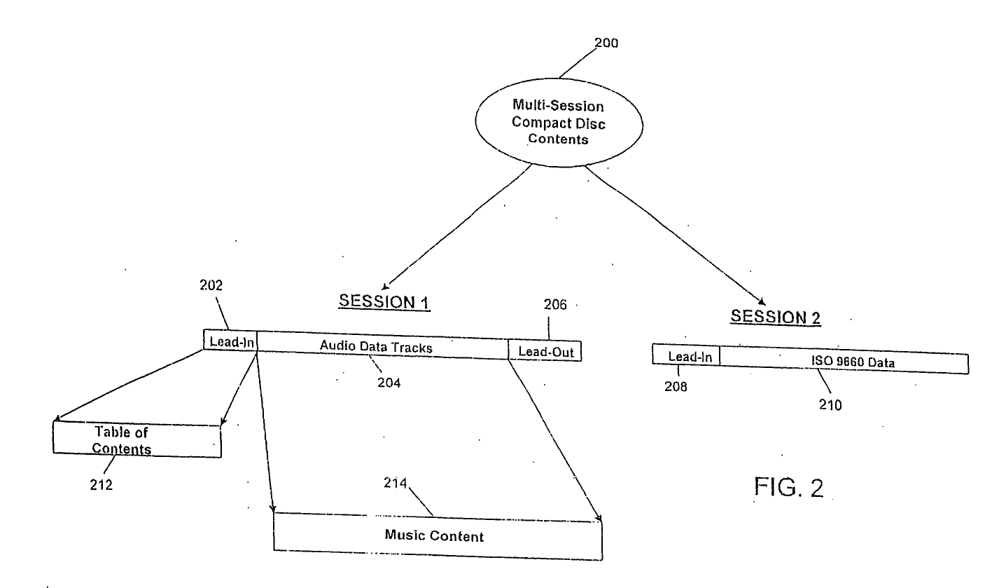

FIG. 2 illustrates the contents 200 of a multiple session compact disc, for example CD 106, recorded according to the present invention. CD 106 contains contents 200. As mentioned above, according to the present invention, contents 200 corresponds to a multiple session CD having sessions indicated as SESSION 1 and SESSION 2 in FIG. 2.

SESSION 1 contains a lead-in area 202, a program area 204, and a lead-out area 206. Program area 204 contains data tracks containing audio music content 214, and lead-in area 202 contains a table of contents 212 corresponding to these data tracks. Lead-out area 206 acts as a spacer between sessions and indicates the location of SESSION 2 on CD 106. The storage format of the digital content in SESSION 1 conforms to industry standards except as discussed herein. Certain modifications (discussed below) are made to control values associated with table of contents 212. These modifications include the addition of extra entries in the TOC for each track beyond the 3 instances defined by the standard. These modifications further include identifying SESSION 1 as digital data in the first number of valid TOC entries, and as audio data in the remaining instances, even though SESSION 1 actually contains audio data tracks in program area 204. Alternate variations of identifying each TOC entry as data or audio shall fall within this present invention. Certain other modifications (also discussed below) are made to error checking and timing values associated with control information stored with music content 214.

SESSION 2 contains a lead-in area 208 and a user data area 210 containing digital data. The storage format of the digital content in SESSION 2 conforms to industry standards for digital data sessions, and in particular, the data stored in user data area 210 conforms to the ISO 9660 standard for CD-ROM data storage. User data area 210 contains an information file or computer program, for example, that is automatically read by the operating system when computer 101 reads SESSION 2.

In other embodiments, SESSION 2 could contain MP3 files that correspond to the audio tracks stored in SESSION 1. Thus, if a music publisher incorporated digital content concealment as described below into an original audio CD purchased by a consumer, then the consumer could still burn the audio CD for personal use. This could be accomplished by programming recording software 104 to recognize a flag placed by a music publisher on the original audio CD that directs the use of SESSION 2 as the music source. Alternatively, recording software 104 can automatically obtain source music content from SESSION 2 in the event that data cannot be read from SESSION 1 due to use of the digital content concealment approach described below.

According to the present invention, when CD 106, recorded as described herein, is mounted in a CD-ROM drive of a digital computer (not shown), audio music content 214 cannot be read by the digital computer because the control data of SESSION 1 has intentional errors introduced by the current invention such as, for example, the identification of SESSION 1 as digital data and other errors as more fully described below. When the digital computer attempts to read program area 204 as digital data, the digital computer aborts reading the data because the audio content in program area 204 does not conform to the ISO 9660 data standard.

Because CD 106 is a multiple session CD, after the digital computer aborts the attempt to read SESSION 1, the digital computer next attempts to read SESSION 2 (as is standard) and successfully reads the information stored in user data area 210, which contains, for example, an information file or a computer program that may be automatically launched by the digital computer.

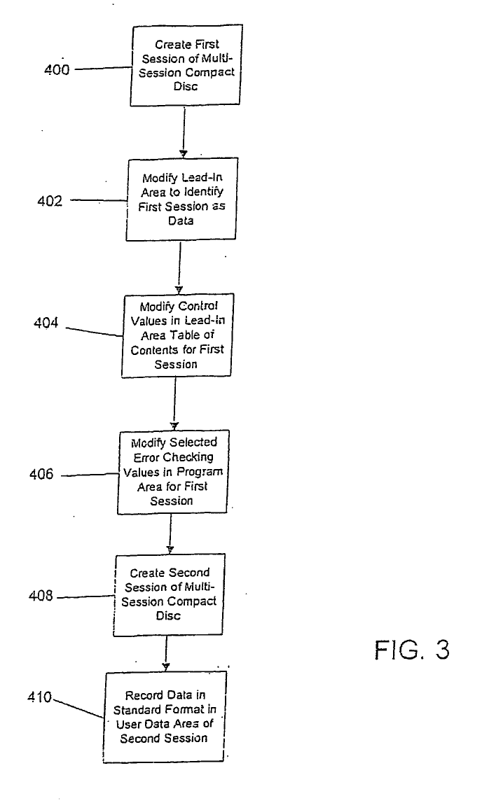

FIG. 3 is a flow diagram illustrating the digital content concealment and authorized distribution method according to the present invention. In step 400, a first audio session of multiple session CD 106 is created. In step 402, lead-in area 202 is modified to identify the first session as containing data.

In step 404, selected control values in table of contents 212 are set to non-standard values (as discussed below). In step 406, selected error checking values in program area 204 are modified to non-standard values. The modifications of steps 404 and 406 are done to conceal or prevent reading of musical content 214 by personal computers and other types of CD copiers and readers.

In step 408, a second session of CD 106 is created. In step 410, an HTML file or other data or identification information and/or a computer program are stored in user data area 210. The identification information could, for example, be used to identify the version or type of recording software 104 used to burn CD 106, or provide other information about the nature of the source of the music recorded onto CD 106.

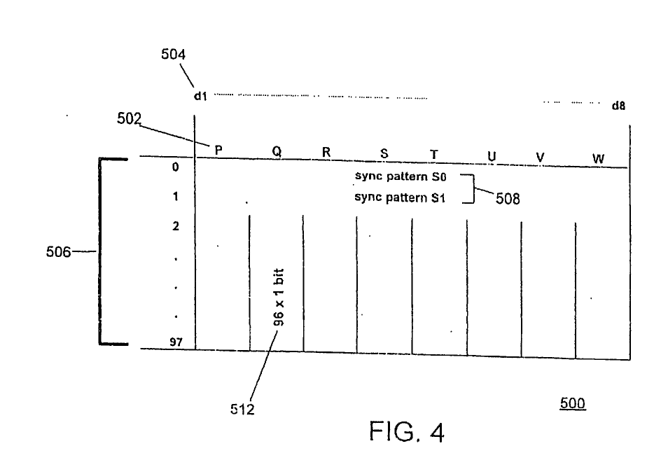

FIG. 4 illustrates the subcode structure 500 according to the standards for audio CDs. In general, data is stored on an audio CD in standard so-called “frames” in program area 204, where each single frame corresponds to 1/75^{th} of a second of playing time. Each frame contains the audio content for that time period and also contains additional control and error checking information stored in a portion of the same frame. The control information is split into 8 channels 502 (indicated by the letters P, Q, R, S, T, U, V, and W) as defined in the standards such as, for example, in the Red Book.

The channels are stored in the frame in an interleaved manner according to the standards in so-called 98 small frames indicated as 0, 1, 2 . . . 97 at reference number 506. Small frames 0 and 1 are reserved by the standards for sync patterns S0 and S1 (indicated by reference number 508), which are only used internally within the CD player hardware and do not store any actual channel data. The remaining 96 small frames each store 1 bit of channel data, indicated as bits d1 . . . d8 (indicated by reference number 504) so that each channel stores 96 bits per frame. These 96 bits are indicated for the Q channel by reference number 512. Each of small frames 506 in subcode structure 500 contains 8 bits (to form a single control byte in the interleaved frame structure mentioned above), and each frame contains a total of 96 such control channel bytes.

Frames are also used to store data in lead-in area 202. Table of contents 212 is typically stored in the Q channel of each frame of lead-in area 202, and the audio content of each frame in the lead-in area is typically zero.

FIG. 5 illustrates the standard channel Q logical data format 600 for subcode structure 500. As mentioned above, the Q channel for each frame stores 96 bits of data, which is structured as indicated in data format 600. Fields 602 and 612 correspond to the standard sync patterns mentioned above and are not part of the Q channel data.

The Q channel data is structured into fields 604, 606, 608, and 610. Field 604 is a control field that defines, among other things, whether data in the program area of a CD is audio or digital data. Field 606 is an address field that indicates the mode for a subset of format 600 (discussed below). Field 608 contains the data bits for the Q channel, and field 610 contains error checking values, which are implemented in the standards as a cyclical redundancy check (CRC) on the control, address, and data fields 604, 606, and 608.

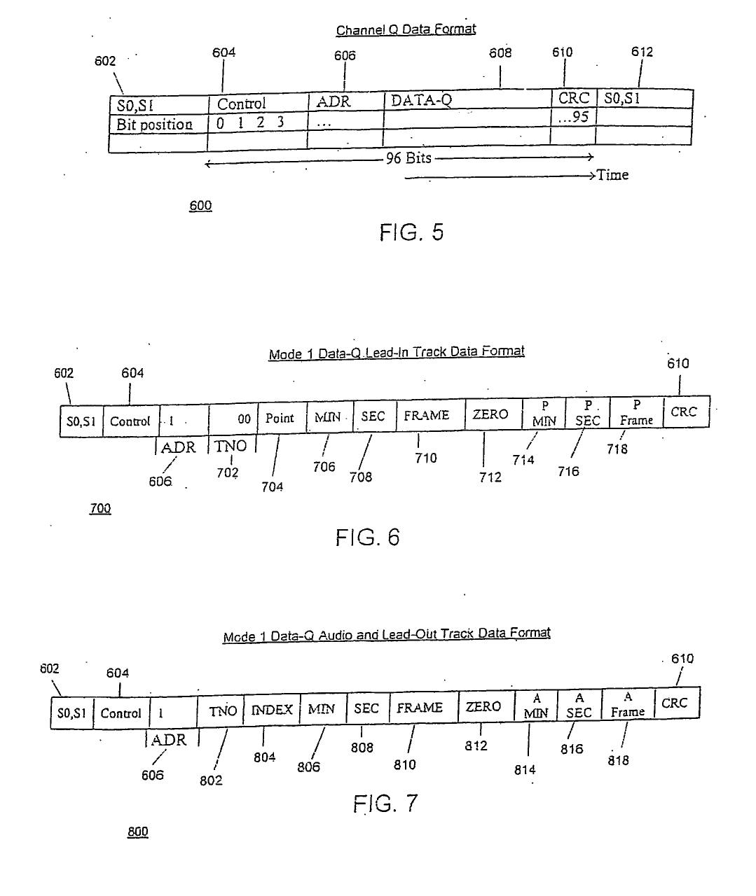

FIG. 6 illustrates the standard mode 1 Data-Q lead-in track format 700 for the channel Q data format 600 of FIG. 5. The format in FIG. 6 is used to store the information for table of contents 212 on CD 106. By industry practice, audio CDs typically use standard mode 1 as the value for address field 606 in lead-in area 202, indicated by a value of 1 in the ADR field of FIG. 6. The fields corresponding to DATA-Q field 608 are standard fields 702-718 as defined in the standards. The TNO field is set by the standards to zero for all records in table of contents 212.

FIG. 7 illustrates the standard mode 1 Data-Q audio and lead-out track format 800 for the channel Q data format 600 of FIG. 5. The format in FIG. 7 is used to store the channel Q data for music content 214 in program area 204. By industry practice, audio CDs also use standard mode I as the value for address field 606 in the program and lead-out areas 204 and 206. The fields corresponding to DATA-Q field 608 for audio and lead-out track data are standard fields 802-818 as defined in the standards.

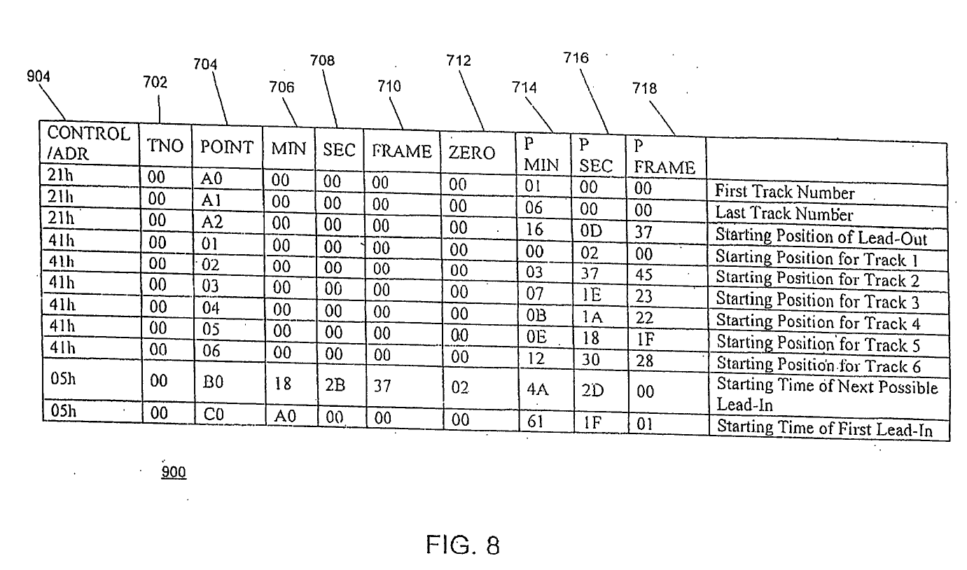

FIG. 8 is a table 900 illustrating an example according to the present invention of table of contents 212 for SESSION 1 of CD 106. Table 900 is a simplified version of the data in an actual table of contents, which according to the standards has each record repeated three times and the entire set of records repeated several times throughout lead-in area 202. Each record (or row) in table 900 corresponds to a single frame or 1/75^{th} second of lead-in running time on CD 106.

Column 904 of table 900 contains values in hexadecimal form that correspond to the values of the 8 bits contained in control and address fields 604 and 606 of FIGS. 5-7. Table 900 also contains the corresponding exemplary values for standard fields 702-718 of the Q channel data format.

According to the present invention, the control/address (also referred to herein as “control”) values in column 904 are set in non-standard ways to conceal music content 214. For those frames in which the POINT field has a value between 1 and 99, which corresponds to a track number, the control/address byte in column 904 is set to 41h. This value identifies the record as a mode 1 record and identifies CD 106 as having digital data in program area 204. It should be recalled that the contents of program area 204 are actually recorded as standard audio data. Identifying the track data as digital data prevents program area 204 from being read by substantially most personal computers and also prevents digital audio extraction using substantially most of the hardware and software currently available for such purpose including, for example, most ripping software programs. The concealment of the digital audio content is accomplished because computers and ripping software usually check the table of contents to determine the location of the audio content on CD 106 (i.e., the starting and ending points of the data tracks). Because the table of contents identifies some number of tracks as being digital data, most computers and ripping software do not operate to extract and/or play music content 214 from CD 106. Computers and ripping software that bypass the table of contents and attempt to read the program area 204 as audio will generally experience problems extracting the digital audio content due to the intentional errors introduced to the program area 204 during the recording process. According to the present invention, the table of contents 212 errors and program area 204 errors need not be incorporated on a CD simultaneously but may be incorporated individually while still obtaining a desirable level of copy protection.

Although computers in general are not able to read content from program area 204, audio CD players are able to play music content 214 from program area 204 because such players do not check the control values stored in table of contents 212 and because such players are generally accustomed to handling errors introduced into the program area 204 of the CD. Thus, such audio players are not affected by the identifying of stored content as data content rather than as audio content, nor of the introduction of errors into the program area 204.

For those frames in which the POINT field is equal to the standard values of A0, A1, and A2 (which correspond to a specific standard type of table of contents information relating to the location of the first and last data tracks and the lead-out), the control/address byte is set to a hexadecimal value of 21 (indicated as 21h). This value identifies the record as a mode 1 record and CD 106 as having audio data in the program area. This value is selected to be different from the control value of 41h for those frames in which the POINT field has a track number value so that the control byte value is changed more frequently than is permitted under the standards. As a result, some computer systems such as, for example, an APPLE MACINTOSH computer operating under the MAC OS 9.0 operating system, will not read music content 214 from program area 204. This occurs because the MAC OS 9.0 operating system expects table of contents 212 to be compliant with the Red Book standards. According to the standards, the control byte value, if changed, must last at least 2 seconds, which corresponds to 150 frames.

The last two rows of table 900 have the control/address byte set to 05h. This corresponds to a standard control byte used to indicate that CD 106 is a multiple session CD, which corresponds to a so-called mode 5 under the standards. Specifically, these two mode 5 records are used to identify the starting time of the lead-in areas for each of the first and second sessions of CD 106.

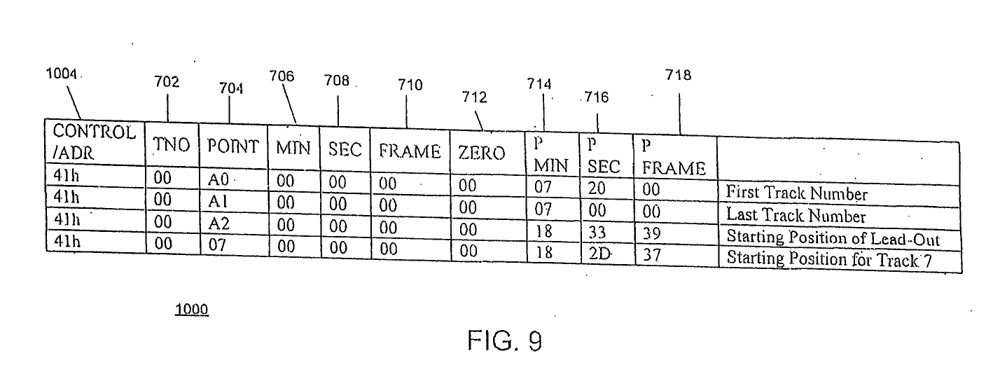

FIG. 9 is a table 1000 illustrating an example according to the present invention of a table of contents for SESSION 2 of CD 106. Lead-in area 208 uses the Q channel to store table of contents information similarly as discussed above for SESSION 1. Table 1000 is a simplified version of the data in the actual table of contents, as discussed above for FIG. 8. The presence of SESSION 2 on CD 106 aids in the prevention of digital audio extraction because some ripping software programs do not operate on multiple session CDs.

Column 1004 of table 1000 contains values in hexadecimal form that correspond to the values of the 8 bits contained in control and address fields 604 and 606 of FIGS. 5-7. Table 1000 also contains the corresponding exemplary values for standard fields 702-718 of the Q channel data format discussed above.

According to the present invention, the control bytes in column 1004 are set to a value of 41h to indicate that the record is a mode 1 record in the Q channel and that user data area 210 contains digital data stored according to the ISO 9660 standards. The control value of 41 h corresponds correctly to the type of data stored in SESSION 2. When CD 106 is placed into a CD-ROM drive of a digital computer, as discussed above, it encounters a read error when attempting to read SESSION 1 and next attempts to read SESSION 2 according to, the standards. However, the CD-ROM drive is able to normally read the digital data from SESSION 2.

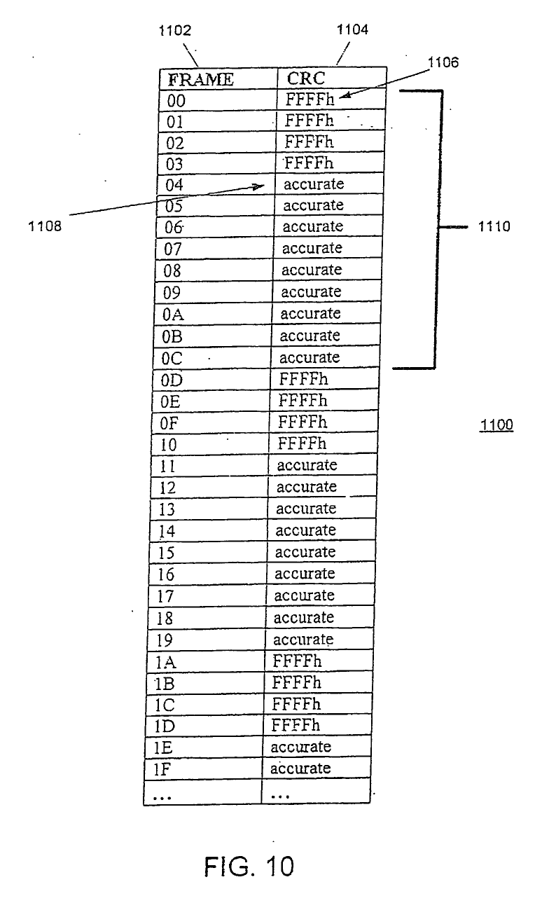

FIG. 10 is a table 1100 illustrating an example of modified CRC values in the channel Q data of program area 204 of CD 106. According to the present invention, in addition to the modifications made to the control values as discussed above, changes are also made to the error checking values, implemented here in the Q channel as CRC values in field 610 (see FIG. 5). In general, a certain proportion of the CRC values for the audio content in program area 204 of SESSION 1 are modified to periodically repeat throughout program area 204 as discussed in more detail below. These modifications are made beginning 5 seconds into each track of program area 204 and continuing throughout all frames of subject track, and repeating in a similar manner for every track in user program 204.

Column 1102 of table 1100 lists exemplary frame addresses in hexadecimal format starting with address 00. For purposes of illustration, the starting logical block address for the first frame is 00, but it should be appreciated that the actual first frame in the program area 204 typically corresponds to the beginning of a standard period of silence (typically having a duration of two seconds and known as “pre-gaps”) immediately following the frames for the table of contents and has a logical block address of, for example, FFFFFF6Ah. According to the present invention, modified CRC values are used starting with the first frame residing 5 seconds into each track from the beginning of the 2 second “pre-gap” and continuing throughout the audio track, and then repeated for each track in the program area.

Column 1104 indicates the CRC value stored onto CD 106 for each frame in program area 204. According to the present invention, a set number of initial frames in each period of frames is intentionally set to an inaccurate value, here shown, for example, as FFFFh, which does not accurately correspond to the DATA-Q values stored in field 608 (see FIG. 5). Inaccurate CRC values other than FFFFh could also be selected.

Column 1104 illustrates a frame period 1110 of every 13 frames with the first four frames 1106 of each period set to an inaccurate FFFFh value. The other 9 frames 1108 are set to accurate CRC values according to the standards.

Other variations could be made to the particular inaccurate CRC pattern used according to the invention. For example, the period could be changed to be greater than 13 frames such as, for example, 75 or 150 frames. Also, the proportion of inaccurate CRC values within each period could be increased or decreased. Further, the inaccurate CRC values could be scattered throughout each period rather than being located in a single group of consecutive frame addresses.

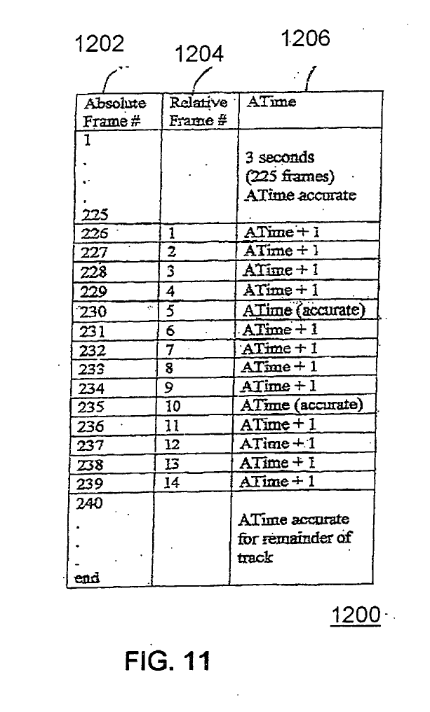

FIG. 11 is a table 1200 illustrating an example of modified ATime values in the channel Q data of program area 204 of CD 106. According to the present invention, in addition to the modifications made to the control values as discussed above, changes are also made to the ATime values, implemented here in the Q channel as ATime errors in fields 814 and 816 (see FIG. 8). In general, a certain proportion of the ATime values for the audio content in program area 204 of SESSION 1 are modified to periodically repeat throughout program area 204 as discussed in more detail below. These modifications are made beginning at either 3 or 5 seconds into each track, depending on the type of modification, of program area 204 and continuing throughout all frames of subject track, and repeating in a similar manner for every track in user program 204.

Column 1202 of table 1200 lists exemplary frame addresses in hexadecimal format starting with address 00. For purposes of illustration, the starting logical block address for the first frame is 00, but it should be appreciated that the actual first frame in the program area 204 typically corresponds to the beginning of a standard period of silence (typically having a duration of two seconds and known as “pre-gaps”) plus some delay (typically having a duration of 3 or 5 seconds) immediately following the frames for the table of contents and has a logical block address of, for example, FFFFFF6Ah. According to the present invention, modified ATime values are used starting with the first frame of this period of silence plus the delay and continuing throughout each audio track and repeating in a similar manner for every track in user program 204.

Column 1104 indicates the CRC value stored onto CD 106 for each frame in program area 204. According to the present invention, a set number of frames in each period of frames is intentionally set to an inaccurate value, here shown, for example, as being one frame less than it should be, which does not accurately correspond to the actual ATime values. Inaccuracies in the ATime values greater than 1 frame could also be selected.

Column 1204 illustrates a frame period 1210 of every 65 frames such that frames 11, 23, 35 and 47 1206 each have ATime values which are 1 frame less than it should be starting 5 seconds after the start of the pregap (assuming a pregap of 2 seconds in length). Column 1204 further illustrates a frame period 1210 of every 65 frames such that frames 1-4, 6-9, 11-14 1207 each have ATime values which are 1 frame more than it should be starting 3 seconds after the start of the pregap (assuming a pregap of 2 seconds in length). The other frames 1208 are set to accurate ATime values according to the standards. Inaccuracies could have been introduced into frames other than frames 11, 23, 35, and 47.

Other variations could be made to the particular inaccurate ATime pattern used according to the invention. For example, the period could be changed to be greater than 65 frames such as, for example, 95 or 130 frames. Also, the proportion of inaccurate ATime values within each period could be increased or decreased. Further, the inaccurate ATime values could be scattered differently throughout each period rather than being located where currently illustrated.

It has been found that most computers and digital audio extraction software such as ripping software will not operate to extract audio data from CD 106 when the periodic CRC errors or ATime errors described above are present. However, it has been learned that substantially most CD audio players, including shock resistant models, will still play music content 214 from program area 204 even though it contains periodic CRC errors. Most such audio players calculate a CRC value during play and compare it to the CRC value of column 1104. Such audio players are designed to tolerate a certain minimal number of CRC errors and continue playing. It has been found that modifications to the CRC in the first four frames of every 13 frames is tolerated by most such audio players. Furthermore, it has been determined that modifications to the ATime in certain frames are similarly tolerated by most such audio players.

The selection of the period and number of bad CRC and ATime values used in each period is a process of balancing playability on audio CD players against preventing computers and digital audio extraction software from being able to extract audio content. In other words, it is desired that the proportion of frames with inaccurate CRC be high to defeat ripping software, without being so high that audio CD players are unable to play the audio content.

The CRC modifications described above could also be made to lead-out area 206, but this is not necessary to accomplish the benefits of the present invention. Lead-in area 202 and all of SESSION 2 do not have the above CRC modifications made.

By the foregoing description, a novel recording system apparatus and method for the recording of CDs with burning software that provides the concealment of digital content on the CD have been disclosed. The present invention has the advantages of protecting published content on burned CDs from unauthorized distribution while providing, for example, the original purchaser of an audio CD with the ability to create a personal compilation CD. Further, the recording system according to the present invention is in alignment with the business interests of the music industry.

The use of the present recording system permits publishers to offer a broader range of audio and video material at lower prices due to a reduction in the loss of profits that might otherwise occur due to unauthorized distribution and pirating. Further, CDs produced according to the present invention are playable in most audio CD players, including shock resistant types, but are not playable in most computer systems and thus cannot be duplicated by ripping software or other software programs using digital audio extraction. Moreover, according to the present invention, the audio music content is not modified and is instead identical to that available from the type of source music used during recording, whether such type is an audio CD, MP3 file, or other type. Accordingly, there is no audio playback degradation relative to the original source when the CD is played on audio players.

In addition to the above advantages, there are other advantages provided to individual computer users. For example, individual consumers or smaller musical arts companies can use the recording system on a personal computer and the method of the present invention to protect CDs that are created for providing to music publishers or others as samples or for CDs that are sold or otherwise provided to customers directly by such individuals or companies.

Although specific embodiments have been described above, it will be appreciated that numerous modifications and substitutions of the invention may be made. For example, the present invention may be applied to other types of formats such as, for example, CD-ROM, CD-R, CD-i, DVD-A, and CDR-G formats. Accordingly, the invention has been described by way of illustration rather than limitation.

1. A system for concealing digital content on a physical medium, comprising:
a personal computer, said personal computer comprising hardware and software that is constructed and arranged to permit a consumer to bum an optical disc; and
wherein at least one of said hardware and said software is configured so as to enable the consumer to bum an optical disc that incorporates copy protection.

2. A system according to claim 1, wherein said copy protection is configured so as to permit improved control over the copying and distribution of content that is stored on the optical disc.

3. A system according to claim 1, wherein said copy protection is configured to frustrate further copying of the content from the optical disc.

4. A system according to claim 1, wherein said optical disc comprises a CD, and wherein said copy protection incorporates means for making modifications to control data that is located in a lead-in area of the CD.

5. A system according to claim 1, wherein said optical disc comprises a CD, and wherein said copy protection incorporates means for verifying a lack of errors in control data on the CD.

6. A system according to claim 1, wherein at least one of said hardware and said software is configured so as to enable the consumer to make a multiple session CD having first and second sessions in which the first session actually contains audio data, but is coded to indicate that it contains digital data, and has intentional errors introduced to its control data.

7. A system according to claim 6, wherein said second session contains digital data in a standard format.

8. A system according to claim 1, wherein at least one of said hardware and said software is configured so as to enable the consumer to bum a multisession optical disc.

9. A system according to claim 8, wherein at least one of said hardware and said software is configured so as to enable the consumer to burn a multisession optical disc comprising a first session containing content in a first file format and a second session containing the same content in a second file format.

10. A system according to claim 8, wherein at least one of said hardware and said software is further configured so as to enable the consumer to bum a computer program on to the optical disc.

11. A system according to claim 9, wherein at least one of said hardware and said software is further configured to bum information on said multisession optical disc that relates to the copy protected status of the content.

12. A system according to claim 1 1, wherein at least one of said hardware and said software is further configured to bum information on to said multisession optical disc that will instruct a personal computer as to the specific form of copy protection that has been applied to the optical disc.

13. A personal computer, comprising:
accessing means for accessing a digital work;
determining means for determining whether said digital work is copy protected; and
recording means for recording a copy protected digital work on to a portable digital media in a copy protected format.

14. A personal computer according to claim 13, wherein said accessing means comprises an optical disc reader for accessing said digital work from an optical disc.

15. A personal computer according to claim 14, wherein said determining means comprises a program that runs on said personal computer, and wherein said program is constructed and arranged to receive copy protection information that is encoded on said optical disc.

16. A personal computer according to claim 15, wherein said recording means is constructed and arranged to record said copy protected digital work on to an optical disc together with said encoded copy protection information.

17. A personal computer according to claim 13, wherein said recording means comprises an optical disc recorder that is constructed and arranged to record said digital work in a first format on a first session of an optical disc and to further record said digital work in a second format on a second session of said optical disc.

18. A personal computer according to claim 17, wherein said recording means is further constructed and arranged to record encoded copy protection information on said optical disc.

19. A copy protected optical disc, comprising:
a digital work recorded on said optical disc in a copy protected format; and
information encoded on said optical disc for a personal computer relating to copying of said digital work by said personal computer on to a recordable optical disc in a copy protected format.

20. A copy protected optical disc according to claim 19, further comprising a computer program recorded on said optical disc that may be executed by the personal computer.

21. A method of distributing digital content, comprising:
providing the digital content to a consumer in a copy protected format; and
enabling the consumer to record the digital content on to an optical disc in a copy protected format that will limit further dissemination of the digital content.

22. A method of distributing digital content according to claim 21, wherein said step of enabling the consumer to record the digital content comprises providing recording software that is executable on a personal computer for permitting recordation of the digital content on to an optical disc in a copy protected format.

23. A method of distributing digital content according to claim 22, wherein said recording software permits the digital content to be recorded in a first file format on a first session of the optical disc and in a second, different file format on a second session of the optical disc, and wherein said recording software is further constructed and arranged to record information on to the optical disc relating to the nature of the copy protection.
